(19) United States
(12) Patent Application Publication
(10) Pub. No.: US 2021/0409805 A1
(43) Pub. Date: Dec. 30, 2021

(54) High Capacity CD-ROM and DVD Player System

(71) Applicant: Ashley Porter, Jacksonville, FL (US)

(72) Inventor: Ashley Porter, Jacksonville, FL (US)

(21) Appl. No.: 16/873,757

(22) Filed: Jun. 26, 2020

(51) Int. Cl. H04N 21/426; H04N 21/41; H04N 21/462

(52) U.S. Cl. CPC H04N 21/42646; H04N 21/4622; H04N 21/41265

(57) ABSTRACT

A high capacity CD-ROM and DVD player system that stores and controls a plurality of CD-ROMs and DVDs without having to eject the CD-ROMs and DVDs. The high capacity CD-ROM and DVD player system includes a server system, a memory system, and a high capacity CD-ROM and DVD player. The housing includes a display, a pair of transparent windows, an on/off button, and a time display. The high capacity CD-ROM and DVD player system includes a corresponding method for playing a plurality of DVDs and CDs with a high capacity CD-ROM and DVD player system and a non-transitory computer storage media having instructions stored thereon which, when executed, execute the overall method.

### BACKGROUND OF THE INVENTION

### Field of the Invention

The present invention is a CD-ROM and DVD player system. More specifically, the present invention is a high capacity CD-ROM and DVD player system.

### Description of the Related Art

CD-ROMs and DVD players are important pieces of equipment to help music lovers and movie and television lovers enjoy music and movie and television shows when they desire. They may also be utilized in combination with other technologies such as a wireless technology standard used for exchanging data between fixed and mobile devices over short distances using short-wavelength UHF radio waves in the industrial, scientific and medical radio band or BLUETOOTH® and client server technology as well.

There is a need for a high capacity CD-ROM and DVD player system that may store and control CD-ROMs and DVDs without having to eject the CD-ROMs and DVDs.

### BRIEF SUMMARY OF THE INVENTION

The present invention is a CD-ROM and DVD player system. More specifically, the present invention is a high capacity CD-ROM and DVD player system.

The high capacity CD-ROM and DVD player system includes a server system with a processor system, a communications interface, a communications system, an input system and an output system, the server system having access to a communications network, a memory system with an operating system, a communications module, a web browser module, a web server application and a high capacity CD-ROM and DVD player system non-transitory storage media, the high capacity CD-ROM and DVD player system non-transitory storage media includes a plurality of high capacity CD-ROM and DVD player system data, the memory system is in communication with the server system through the communications network, and a high capacity CD-ROM and DVD player in electrical communication with the server system.

It is an object of the present invention to provide a high capacity CD-ROM and DVD player system that stores in the range of 300 to 500 CDs and DVDs.

It is an object of the present invention to provide a high capacity CD-ROM and DVD player system that controls CD-ROMs and DVDs without having to eject the CD-ROMs and DVDs.

It is an object of the present invention to provide a high capacity CD-ROM and DVD player system that switches from playing one or more CD-ROMs to one or more DVDs without having to eject the CD-ROMs and DVDs.

It is an object of the present invention to provide a high capacity CD-ROM and DVD player system that digitally stores in the range of 300 to 500 CDs and DVDs on a memory system.

It is an object of the present invention to provide a high capacity CD-ROM and DVD player system that includes a remote control to control in the range of 300 to 500 CDs and DVDs.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a system overview of a high capacity CD-ROM and DVD player system, in accordance with one embodiment of the present invention.

FIG. 2A illustrates a block diagram of a client system, in accordance with one embodiment of the present invention.

FIG. 2B illustrates a block diagram of a server system, in accordance with one embodiment of the present invention.

FIG. 3 illustrates a front perspective view of a high capacity CD-ROM and DVD player system, in accordance with one embodiment of the present invention.

FIG. 4 illustrates a side perspective view of a high capacity CD-ROM and DVD player system, in accordance with one embodiment of the present invention.

FIG. 5 illustrates a front environmental perspective view of a high capacity CD-ROM and DVD player system, in accordance with one embodiment of the present invention.

FIG. 6 illustrates an overhead perspective view of a housing, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

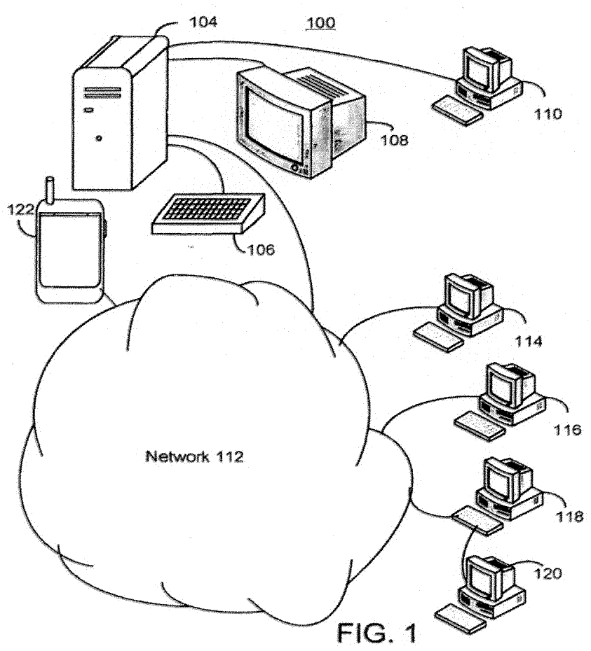

FIG. 1 illustrates a system overview of a high capacity CD-ROM and DVD player system 100, in accordance with one embodiment of the present invention.

The overall system 100 includes a server system 104, an input system 106, an output system 108, a plurality of client systems 110, 114, 116, 118 and 120, a communications network 112 and a hand-held device 122. In other embodiments, the overall system 100 may include additional components and/or may not include all of the components listed above.

The server system 104 may include one or more servers. One server 104 may be the property of the distributor of any related software or non-transitory storage media. In other embodiments, the overall system 100 may include additional components and/or may not include all of the components listed above.

The input system 106 may be used for entering input into the server system 104, and may include any one of, some of, any combination of, or all of a keyboard system, a mouse system, a track ball system, a track pad system, a plurality of buttons on a handheld system, a scanner system, a wireless receiver, a microphone system, a connection to a sound system, and/or a connection and/or an interface system to a computer system, an intranet, and/or the Internet (i.e., IrDA, USB), for example.

The output system 108 may be used for receiving output from the server system 104, and may include any one of, some of, any combination of or all of a monitor system, a wireless transmitter, a handheld display system, a printer system, a speaker system, a connection or an interface system to a sound system, an interface system to one or more peripheral devices and/or a connection and/or an interface system to a computer system, an intranet, and/or the Internet, for example.

The overall system 100 illustrates some of the variations of the manners of connecting to the server system 104, which may be an information providing website (not shown). The server system 104 may be directly connected and/or wirelessly connected to the one or more client systems 110, 114, 116, 118 and 120 and are connected via the communications network 112. Client systems 120 may be connected to the server system 104 via the client system 118. The communications network 112 may be any one of, or any combination of, one or more local area networks or LANs, wide area networks or WANs, wireless networks, telephone networks, the Internet and/or other networks. The communications network 112 may include one or more wireless portals (not shown). The client systems 110, 114, 116, 118 and 120 are any system that an end user may use to access the server system 104. For example, the client systems 110, 114, 116, 118 and 120 may be personal computers, workstations, laptop computers, game consoles, handheld network enabled audio/video players and/or any other network appliance.

The client system 120 accesses the server system 104 via the combination of the communications network 112 and another system, which in this example is the client system 118. The client system 120 is an example of a handheld wireless device 122, such as a mobile phone or a handheld network enabled audio/music player or the like, which may also be used for accessing network content.

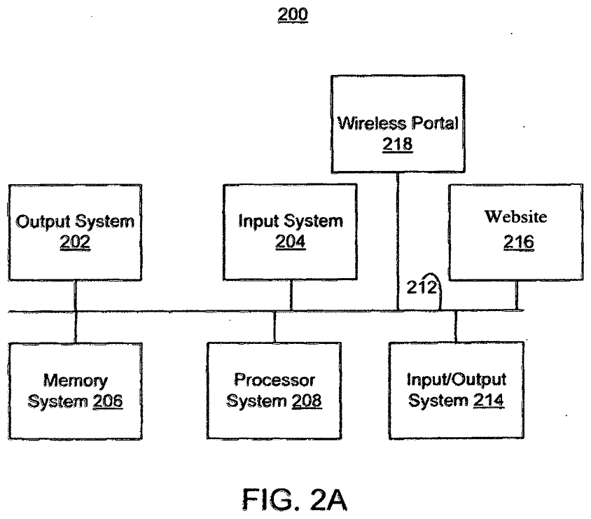

FIG. 2A illustrates a block diagram of a client system 200 that may be used in combination with a client system for a high capacity CD-ROM and DVD player system, in accordance with one embodiment of the present invention.

The client system 200 may include an output system 202, an input system 204, a memory system 206, a processor system 208, a communications system 212, an input/output system 214, a website 216 and a wireless portal 218. Other embodiments of the client system 200 may not have all of the components and/or may have other embodiments in addition to or instead of the components listed above.

The client system 200 may be any one of the client systems 110, 114, 116, 118, 120, and/or handheld wireless device 122 that may be used as one of the network devices of FIG. 1. In other embodiments, the client system 200 may include additional components and/or may not include all of the components listed above. The output system 202 may include any one of, some of, any combination of or all of a monitor system, a wireless transmitter, a handheld display system, a printer system, a speaker system, a connection or an interface system to a sound system, an interface system to peripheral devices and/or a connection and/or an interface system to a computer system, a smart television, an intranet, and/or the Internet, for example.

The input system 204 may include any one of, some of, any combination of or all of a keyboard system, a mouse system, a track ball system, a track pad system, one or more buttons on a handheld system, a scanner system, a wireless receiver, a microphone system, a connection to a sound system, and/or a connection and/or an interface system to a computer system, an intranet, and/or the Internet (i.e., Infrared Data Association or IrDA, Universal Serial Bus or USB), for example. The memory system 206 may include, for example, any one of, some of, any combination of or all of a long-term storage system, such as a hard drive, a short-term storage system, such as a random-access memory; a removable storage system, such as a floppy drive or a removable drive, and/or a flash memory. The memory system 206 may include one or more machine-readable mediums that may store a variety of different types of information. The term machine-readable medium is used to refer to any medium that is structurally configured for carrying information in a format that is readable by a machine. One example of a machine-readable medium is a computer-readable medium. The memory system 206 also stores a high capacity CD-ROM and DVD player system.

The processor system 208 may include any one of, some of, any combination of, or all of multiple parallel processors, a single processor, a system of processors having one or more central processors and/or one or more specialized processors dedicated to specific tasks. The processor system 208 implements the programs stored in the memory system 206. The communications system 212 communicatively buttons the output system 202, the input system 204, the memory system 206, the processor system 208, and/or the input/output system 214 to each other. The communications system 212 may include any one of, some of, any combination of, or all of one or more electrical cables, fiber optic cables, and/or means for sending signals through air or water (i.e., wireless communications), or the like. Some examples of means for sending signals through air and/or water include systems for transmitting electromagnetic waves such as infrared and/or radio waves and/or systems for sending sound waves.

The input/output system 214 may include devices that have the dual function as input and output devices. For example, the input/output system 214 may include one or more touch sensitive screens, which display an image and therefore are an output device and accept input when the screens are pressed by a finger or a stylus, for example. The touch sensitive screens may be sensitive to heat, capacitance and/or pressure. One or more of the input/output devices may be sensitive to a voltage or a current produced by a stylus, for example. The input/output system 214 is optional and may be used in addition to or in place of the output system 202 and/or the input device 204.

The client systems 110, 114, 116, 118, 120 and the handheld wireless device 122 may also be tied into a website 216 or a wireless portal 218 which is also tied directly into the communications system 212. Any website 216 or wireless portal 218 would also include software and a website module (no number) to maintain, allow access to and run the website as well.

FIG. 2B illustrates a block diagram of a server system 104 that may be a high capacity CD-ROM and DVD player system, in accordance with one embodiment of the present invention.

The server system 104 may include a high capacity DVD and CD player system having a power source 220, an output system 230, an input system 240, a memory system 250, which may store an operating system 251, a communications module 252, a web browser module 253, a web server application 254, a non-transitory storage media for a high capacity CD-ROM and DVD player system 255 and an electronic text repository 256. The server system 104 may also include a processor system 260, a communications interface 270, a communications system 275 and an input/output system 280. In other embodiments, the server system 104 may include additional components and/or may not include all of the components listed above.

The output system 230 may include any one of, some of, any combination of, or all of a monitor system, a handheld display system, a printer system, a speaker system, a connection or interface system to a sound system, an interface system to one or more peripheral devices and/or a connection and/or interface system to a computer system, an intranet, and/or the Internet, for example.

The input system 240 may include any one of, some of, any combination of, or all of a keyboard system, a mouse system, a track ball system, a track pad system, one or more buttons on a handheld system, a scanner system, a microphone system, a connection to a sound system, and/or a connection and/or an interface system to a computer system, an intranet, and/or the Internet (i.e., IrDA, USB), for example.

The memory system 250 may include, for example, any one of, some of, any combination of, or all of a long-term storage system, such as a hard drive; a short-term storage system, such as random-access memory; a removable storage system, such as a floppy drive or a removable drive and/or a flash memory. The memory system 250 may include one or more machine-readable mediums that may store a variety of different types of information. The term machine-readable medium is used to refer to any medium capable of carrying information that is readable by a machine. One example of a machine-readable medium is a computer-readable medium. The memory system 250 may store a high capacity CD-ROM and DVD player system. The operating system 251 controls all software or non-transitory storage media and hardware of the overall system 100. The communications module 252 may enable the server system 104 to communicate on the communications network 112. The web browser module 253 allows for browsing the Internet. The web server application 254 serves a plurality of web pages to client systems that request the webpages, thereby facilitating browsing on the Internet.

The processor system 260 may include any one of, some of, any combination of, or all of multiple parallel processors, a single processor, a system of processors having one or more central processors and/or one or more specialized processors dedicated to specific tasks. The processor system 260 may implement the machine instructions stored in the memory system 250.

In an alternative embodiment, the communication interface 270 allows the server system 104 to interface with the network 112. In this embodiment, the output system 230 sends communications to the communication interface 270. The communications system 275 communicatively buttons the output system 230, the input system 240, the memory system 250, the processor system 260 and/or the input/output system 280 to each other. The communications system 275 may include any one of, some of, any combination of, or all of one or more electrical cables, fiber optic cables, and/or sending signals through air or water (i.e., wireless communications), or the like. Some examples of sending signals through air and/or water include systems for transmitting electromagnetic waves such as infrared and/or radio waves and/or systems for sending sound waves.

The input/output system 280 may include devices that have the dual function as the input and output devices. For example, the input/output system 280 may include one or more touch sensitive screens, which display an image and therefore are an output device and accept input when the screens are pressed by a finger or a stylus, for example. The touch sensitive screens may be sensitive to heat and/or pressure. One or more of the input/output devices may be sensitive to a voltage or a current produced by a stylus, for example. The input/output system 280 is optional and may be used in addition to or in place of the output system 230 and/or the input device 240.

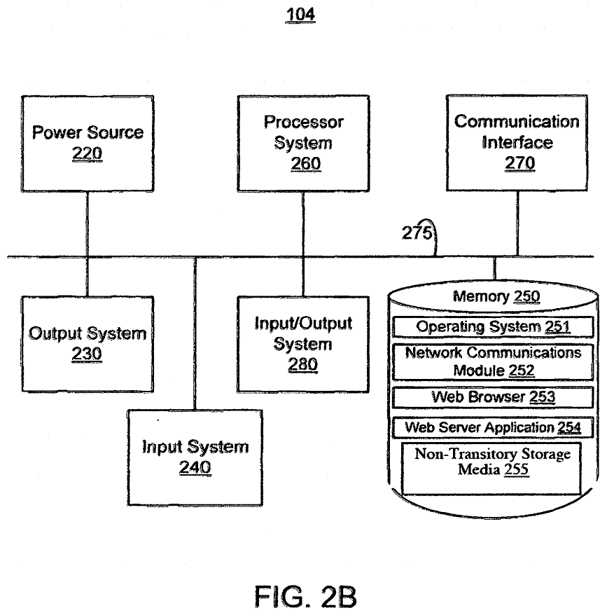

FIG. 3 illustrates a side perspective view of a high capacity CD-ROM and DVD player system 300, in accordance with one embodiment of the present invention.

The high capacity CD-ROM and DVD player system 300 may the housing 310 having a display 312, a pair of transparent windows 314, an on/off button 316, and a time display 318.

The display 312 may be a digital display 312A or the like. The display 312 may include a progress bar 312B that runs across the display 312 as one of the CDs 315 or one of the DVDs 317 is played. The display 312 may display a plurality of CD data 315A and a plurality of DVD data 317A. The pair of transparent windows 314 may be a pair of elongated transparent windows 314A to allow a person to view the CDs 315 and the DVDs 317 stored inside the housing 310. The on/off button 316 may be depressed to turn on and turn off the high capacity CD-ROM and DVD player system 300. The time display 318 may be a digital time display 318A that more specifically may be a liquid electrode display or LED display 318B or a liquid crystal display or LCD display 318C.

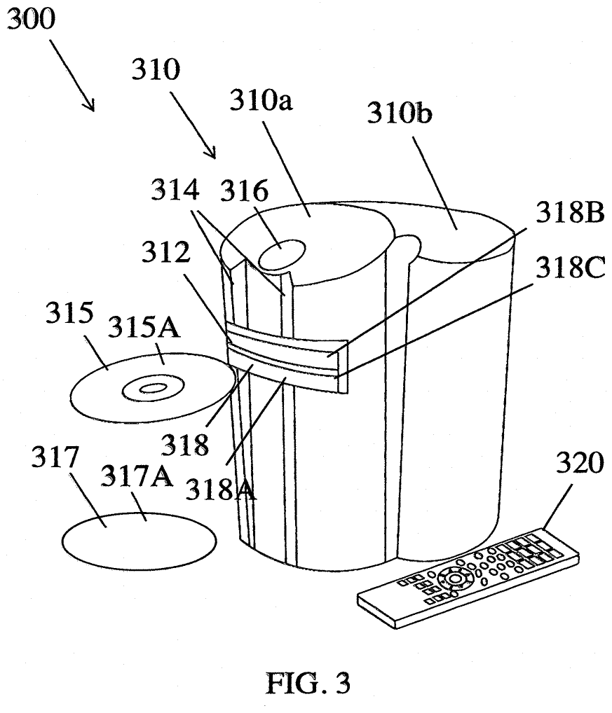

FIG. 4 illustrates a front perspective view of a high capacity CD-ROM and DVD player system 300, in accordance with one embodiment of the present invention.

The high capacity CD-ROM and DVD player system 300 may include a housing 310, a remote control 320, a BLUETOOTH® signal component 330, a cloud computer component 340, and a server system 350.

The housing 310 may have a first generally cylindrical shape 310A and a second generally cylindrical shape 310B or the like. The first cylindrical shape 310A is relatively smaller in diameter than the second generally cylindrical shape 3106. The first cylindrical shape 310A may have a first generally cylindrical interior 312A to accommodate, store, and control a plurality of compact discs or CDs 314. The second generally cylindrical shape 310B may have a second generally cylindrical interior 312B to accommodate, store, and control a plurality of digital video discs or DVDs 316. The CDs 314 may be stored on top of or underneath the DVDs 316 in any order. The housing 310 may store and control in the range of 300 to 500 CDs 314 and DVDs 316 or the like.

The remote control 320 may be in electrical communication with the housing 310 to control playing, arranging, and digitally saving the CDs 314 and the DVDs 316.

The BLUETOOTH® signal component 330 may provide electrical communication between the remote control 320 and the housing 310 to control playing, arranging, and digitally saving the CDs 314 and the DVDs 316.

The cloud computer component 340 may be in communication with a cloud computer system 342 via the network (FIG. 1, 112) between the housing 310 and the client system 104.

The server system 350 may reside within the housing 310 and controls the BLUETOOTH® signal component 330 and the cloud computer component 340.

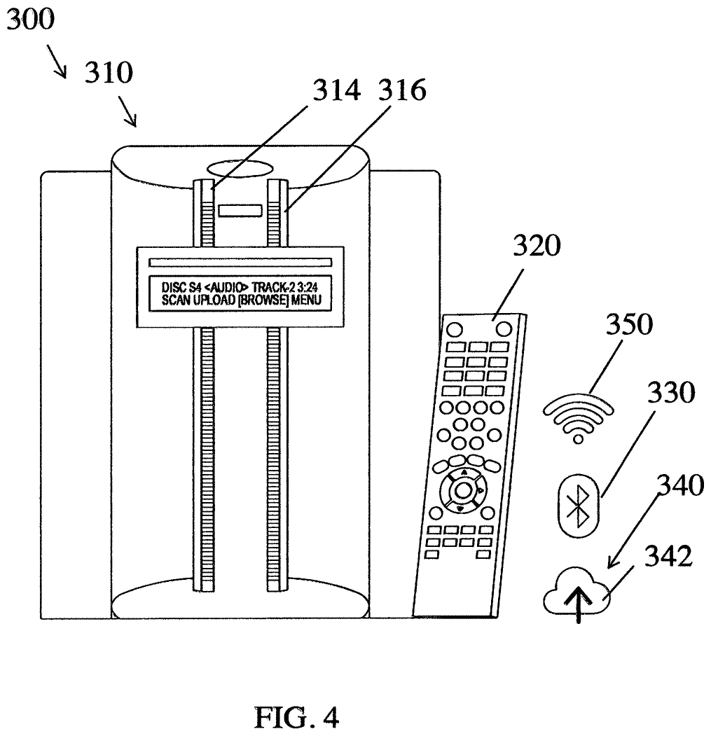

FIG. 5 illustrates a front environmental perspective view of a high capacity CD-ROM and DVD player system 300, in accordance with one embodiment of the present invention.

The high capacity CD-ROM and DVD player system 300 may be a personal computer (FIG. 1, 108) or the like.

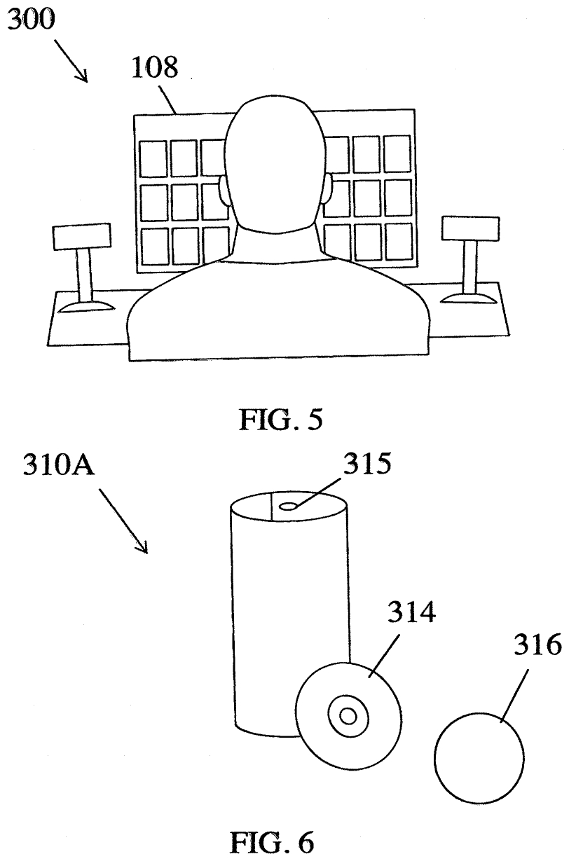

FIG. 6 illustrates an overhead perspective view of a first cylindrical shape 310A, in accordance with one embodiment of the present invention.

The first cylindrical shape 310A may include a centered elongated stem 315 to accommodate the CDs 314 and the DVDs 316 stored in the housing 310.

Use of the high capacity CD-ROM and DVD player system 300 is straightforward. A method for playing a plurality of DVDs and CDs with a high capacity CD-ROM and DVD player system, comprising the steps of obtaining the high capacity CD-ROM and DVD player system, activating the high capacity CD-ROM and DVD player system, utilizing the high capacity CD-ROM and DVD player system within a housing of the high capacity CD-ROM and DVD player system to control playing, arranging, and digitally saving a plurality of CDs and a plurality of DVDs, and shutting down the high capacity CD-ROM and DVD player system.

A remote control is in electrical communication with the housing to control playing, arranging, and digitally saving the CDs and the DVDs.

The overall method may be executed by a non-transitory computer storage media having instructions stored thereon which, when executed, execute the overall method.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A high capacity CD-ROM and DVD player system, comprising:
a server system with a processor system, a communications interface, a communications system, an input system and an output system, the server system having access to a communications network;
a memory system with an operating system, a communications module, a web browser module, a web server application and a high capacity CD-ROM and DVD player system non-transitory storage media, the high capacity CD-ROM and DVD player system non-transitory storage media includes a plurality of high capacity CD-ROM and DVD player system, the memory system is in communication with the server system through the communications network and the electronic text repository includes the general literature and diverse types of content; and
a high capacity CD-ROM and DVD player in electrical communication with the server system to store and control a plurality of CDs and a plurality of DVDs.

2. The system according to claim 1, further comprising a client system, the client system accesses the server system via the communications network.

3. The system according to claim 2, wherein the client system is a system selected from the group consisting of a smart phone, a laptop computer, a personal computer, a workstation, a game console, a handheld network enabled audio/video player, a smart television, or a network appliance.

4. The system according to claim 1, wherein the high capacity CD-ROM and DVD player includes a housing, a remote control, a BLUETOOTH® signal component, and a cloud computer component.

5. The system according to claim 4, wherein the housing includes a display, a pair of transparent windows, an on/off button, and a time display.

6. The system according to claim 4, wherein the housing includes a first generally cylindrical shape and a second generally cylindrical shape.

7. The system according to claim 6, wherein the first cylindrical shape is smaller in diameter than the second generally cylindrical shape.

8. The system according to claim 6, wherein the first cylindrical shape includes a first generally cylindrical interior to accommodate, store, and play the CDs.

9. The system according to claim 6, wherein the first cylindrical shape includes a centered elongated stem to accommodate the CDs and the DVDs stored in the housing.

10. The system according to claim 6, wherein the second generally cylindrical shape includes a second generally cylindrical interior to accommodate, store, and play the DVDs.

11. The system according to claim 1, wherein the CDs are stored on top of or underneath the DVDs in any order.

12. The system according to claim 1, wherein the housing stores and controls in the range of 300 to 500 CDs and DVDs.

13. The system according to claim 4, wherein the remote control is in electrical communication with the housing to control playing, arranging, and digitally saving the CDs and the DVDs.

14. The system according to claim 4, wherein The BLUETOOTH® signal component provide electrical communication between the remote control and the housing to control playing, arranging, and digitally saving the CDs and the DVDs.

15. The system according to claim 4, wherein the cloud computer component is in communication with a cloud computer system via the network between the housing and the client system.

16. The system according to claim 4, wherein the server system resides within the housing and controls the BLUETOOTH signal component and the cloud computer component.

17. A method for playing a plurality of DVDs and CDs with a high capacity CD-ROM and DVD player system, comprising the steps of:
obtaining the high capacity CD-ROM and DVD player system;
activating the high capacity CD-ROM and DVD player system;
utilizing the high capacity CD-ROM and DVD player system within a housing of the high capacity CD-ROM and DVD player system to control playing, arranging, and digitally saving a plurality of CDs and a plurality of DVDs; and
shutting down the high capacity CD-ROM and DVD player system.

18. The method according to claim 17, further comprising a remote control is in electrical communication with the housing to control playing, arranging, and digitally saving the CDs and the DVDs.

19. A non-transitory computer storage media having instructions stored thereon which, when executed, execute a method comprising the steps of:
obtaining the high capacity CD-ROM and DVD player system;
activating the high capacity CD-ROM and DVD player system;
utilizing the high capacity CD-ROM and DVD player system within a housing of the high capacity CD-ROM and DVD player system to control playing, arranging, and digitally saving a plurality of CDs and a plurality of DVDs; and
shutting down the high capacity CD-ROM and DVD player system.

20. The non-transitory computer storage media according 6to claim 19, further comprising a remote control is in electrical communication with the housing to control playing, arranging, and digitally saving the CDs and the DVDs.
